(19) United States
(12) Patent Application Publication
(10) Pub. No.: US 2004/0267614 A1
(43) Pub. Date: Dec. 30, 2004

(54) Catalog for targeted and non-targeted products for e-commerce

(75) Inventors: Sau Chu Chan, Thomhill (CA); Victor S. Chan, Thomhill (CA); Lev Mirlas, Thomhill (CA)

Correspondence Address: John D. Flynn, IBM Corporation, Dep. T81/Bldg. 503, PO Box 12195, Research Triangle Park, NC, 22709, US

(73) Assignee: International Business Machines Corporation, Armonk, NY

(21) Appl. No.: 10/761,175

(22) Filed: Jan. 20, 2004

(30) Foreign Application Priority Data
Jun. 27, 2003 (CA) 2,433,921

(51) Int. Cl. G06F 17/60

(52) U.S. Cl. 705/14; 705/27

(57) ABSTRACT

The invention provides an e-commerce catalog capable of offering a plurality of products for a vendor to prospective customers including a master targeted product set of selected products that is not to be available to non-targeted customer and, a targeted product set for a targeted customer, or targeted product sets for respective targeted customers. The catalog may include a non-targeted product set available to targeted customers. The non-targeted product set may be made available to public customers. The catalog may present views of products from targeted product sets to respective targeted customers. The catalog may present a view of products from non-targeted product sets to public customers. The catalog may present views of products from targeted product sets and non-targeted product sets. The catalog may include a master targeted product set that is determined in accordance with terms and conditions of trading agreements between a vendor and targeted customers. Each targeted product set may be advantageously determined in accordance with the terms and conditions of a trading agreement between a vendor and a respective targeted customer, or in accordance with terms and conditions of trading agreements between a vendor and said targeted customers.

### PRIORITY BENEFIT AND CROSS REFERENCE TO RELATED APPLICATIONS

This Application claims priority under 35 U.S.C. § 119(a) to Canadian Patent Application No. 2,433,921, filed Jun. 27, 2003, which is hereby incorporated herein by reference in its entirety.

### TECHNICAL FIELD

This invention relates to electronic commerce (e-commerce), and more particularly to catalogs used in e-commerce, and their structure, implementation, and use for implementation in an e-commerce system supporting online stores or businesses accessible by customers through networks such as the Internet.

### BACKGROUND INFORMATION

Catalogs are frequently used by businesses or stores in e-commerce to enable vendors to offer wares or services to customers. These catalogs can be implemented by programs operating on computer systems that can advantageously be accessed over networks such as the World Wide Web to customers so that they can be accessed from customer locations remote from vendors stores or businesses, for instance, by using web browsers having graphical user interfaces (GUIs). At the present time, e-commerce catalogs presented on web sites accessible to customers typically offer standard products to all potential customers accessing the catalogs.

However, a vendor may have a number of different products, some of which are only intended to be available to specific customers. The vendor may elect to present specific products in separate catalogs to which selected customers have access. This may appear to provide security making it difficult for one customer to access products being offered to other customers but presents undue complexity and financial overhead for the vendor as a number of catalogs and corresponding catalog indices need to be maintained, and the vendor may require separate network or Web access sites for secure customer access. It may be advantageous technically and financially for vendors to be able to offer a wide or complete range of products in a single catalog while restricting or limiting the view or access of selected catalog products to a specific set of customers.

It is challenging enough for buyers to find the exact product they want from a catalog of a store. Catalog browsing and searching facilities are helpful to customers, enabling them to find desired products being offered. When customers cannot find products they want in a vendor's catalog and require a way to submit requests for a quote or supply of unlisted or made-to-order products, a way needs to be found to satisfy them and incorporate the desired products in a catalog. The ability for customers to submit RFQs (Request For Quotes) on unlisted, custom, or made-to-order products from a vendor having an e-commerce catalog would tend to attract more customers to purchase from the vendor. It could also be helpful to a vendor if more current products such as made-to-order products or contract products could be presented in the same catalog as regular product offerings. This would make it easier for customers to conduct business with the vendor and may help improve the vendor's sales.

Inasmuch as a vendor would like to supply specific customers with made-to-order products, the vendor would also like to restrict or limit the view and access of some catalog products to a specific set of customers, especially for made-to-order products. After reviewing a request sent from a customer on made-to-order product, a vendor may decide to sell this made-to-order product just to that customer. In order to satisfy the customer and make it easy for the customer to purchase the new product, the vendor will need the ability to create or acquire the new product targeted to this customer, then respond to the customer request with a newly generated catalog entry for the new (made-to-order) product. It is likely that both the vendor and customer will want this new made-to-order product to be accessible or viewable only by this customer or the customer's organization.

For profitability, vendors would also appreciate the ability of adding other customer organizations to a target list of customers eligible to buy targeted products or in suitable situations to make the product available to a broad range of customers or the public when the vendors want to sell the targeted product to other customers in general.

### SUMMARY OF THE INVENTION

The invention herein seeks to overcome the limitations of prior e-commerce catalogs and ordering processes. Aspects of the invention seek to provide a vendor the ability to support made-to-order or targeted products by targeting the products to specific customers by means of targeted product sets. These can be supported in contracts or a made-to-order RFQ process.

Embodiments of the invention seek to provide various advantages, including a method for vendors to respond to made-to-order products in an RFQ; a method for vendors to create target products for a catalog from an RFQ when creating catalog product entries; a method for vendors to provide different views of a catalog to selected customers including products available to public plus products targeted to the selected customers; and a method for vendors to target products through target product sets supported in new or existing contracts.

An embodiment of the invention provides an e-commerce catalog capable of offering a plurality of products for a vendor to prospective customers, including a master targeted product set of selected products that is not to be available to non-targeted customers; and, a targeted product set for a targeted customer, or targeted product sets for respective targeted customers.

The catalog may include a non-targeted product set available to targeted customers. The non-targeted product set may be made available to public customers. The catalog may present views of products from targeted product sets to respective targeted customers. The catalog may present a view of products from non-targeted product sets to public customers. The catalog may present views of products from targeted product sets and non-targeted product sets.

The catalog may include a master targeted product set that is determined in accordance with terms and conditions of trading agreements between the vendor and the targeted customers. Each targeted product set may be advantageously determined in accordance with the terms and conditions of a trading agreement between the vendor and a respective targeted customer, or in accordance with terms and conditions of trading agreements between the vendor and the targeted customers. Catalog pricing of products from the targeted product sets may be determined in accordance with terms and conditions of trading agreements between the vendor and respective targeted customers.

Another aspect of the invention provides a method, which may be computer implemented, for providing an e-commerce catalog capable of offering a plurality of products for a vendor to prospective customers, including providing for the catalog a master targeted product set of selected products that is not to be available to non-targeted customers; and, providing for the catalog targeted product sets for targeted customers.

A non-targeted product set may be made available to targeted customers or to public customers. The method may provide a catalog that presents views of products from targeted product sets to respective targeted customers.

Views of products from non-targeted product sets may be presented to targeted customers. A view of products from non-targeted product sets may be provided to public customers. The method may advantageously provide an e-commerce catalog that presents views of products from targeted product sets and non-targeted product sets. The master targeted product set may be determined in accordance with terms and conditions of trading agreements between the vendor and the targeted customers. Each targeted product set may be determined in accordance with the terms and conditions of a trading agreement between the vendor and a targeted customer. Catalog pricing of products from the master targeted product set may be determined in accordance with terms and conditions of trading agreements between the vendor and the targeted customers. Catalog pricing of products from the targeted product sets may be advantageously determined in accordance with terms and conditions of trading agreements between the vendor and respective targeted customers.

Another embodiment of the invention provides a method of creating and managing made-to-order and targeted products, the method including providing for vendors to respond to made-to-order products in the RFQ submitted from the customers, providing different views of the catalog to different customers which are comprising of products available to public plus products targeted to the customers, and, implementing of targeted products through target product sets support.

Another embodiment of the invention provides a computer program for implementing an e-commerce catalog, capable of offering a plurality of products for a vendor to prospective customers having computer readable program code which can be stored on a medium such as magnetic, optical or random access memory for use by a computer, and including a computer readable program code for providing a master targeted product set of selected products that is not to be available to non-targeted customers, and, a targeted product set for a respective targeted customer.

The computer program product may include computer readable program code for providing a master targeted product set of selected products that is not to be available to non-targeted customers, and, targeted product sets for respective targeted customers. The computer program product may provide code for providing a non-targeted product set available to targeted customers. The non-targeted product set may be made available to public customers. The computer program product may provide code for presenting views of products from targeted product sets to respective targeted customers.

The computer program product may provide computer code for the catalog for presenting a view of products from non-targeted product sets to targeted customers. In another implementation, the code may enable the catalog to present a view of products from non-targeted product sets to public customers. The catalog may present views of products from targeted product sets and non-targeted product sets.

The master targeted product set may be determined in accordance with terms and conditions of trading agreements between the vendor and the targeted customers. Each targeted product set may be determined in accordance with the terms and conditions of a trading agreement between the vendor and a respective targeted customer. Catalog pricing of products from the master targeted product set may be determined in accordance with terms and conditions of trading agreements between the vendor and the targeted customers. Catalog pricing of products from the targeted product sets may be determined in accordance with terms and conditions of trading agreements between the vendor and respective targeted customers.

The computer program embodiments of the invention can be carried by a computer readable modulated carrier signal, such as transmission by radio waves, light, infrared, in open transmission or by electronic or optical cable transmission which permit the program embodiments of the invention to be transmitted to and used by a computer system to implement or augment an e-commerce system.

Another aspect of the invention provides a computer program product for implementing an e-commerce catalog, capable of offering a plurality of products for a vendor to prospective customers the computer program product comprising a computer usable medium having computer readable program code embodied in the medium, including: computer readable program code for implementing the methods of the embodiments described above.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

Reference will now be made, by way of example, to the accompanying drawings which show embodiments of the present invention, in which:

FIG. 1 shows, in flowchart form, a method for a vendor e-commerce system to respond to made-to-order products included in an RFQ and add them to a catalog;

FIG. 2 shows, in flowchart form, a method for a vendor e-commerce system to target products to an RFQ when creating catalog product listings;

FIG. 3 shows, in block diagram form, the relationships between an RFQ, a contract, and terms and conditions of trading agreements;

FIG. 4 shows, in diagrammatic format, an example of a catalog with target products using targeted product sets; and

FIG. 5 illustrates, in block diagram form, an information processing system configurable in accordance with the present invention.

### DETAILED DESCRIPTION

In the following description, numerous specific details are set forth such as specific network configurations, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like-have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

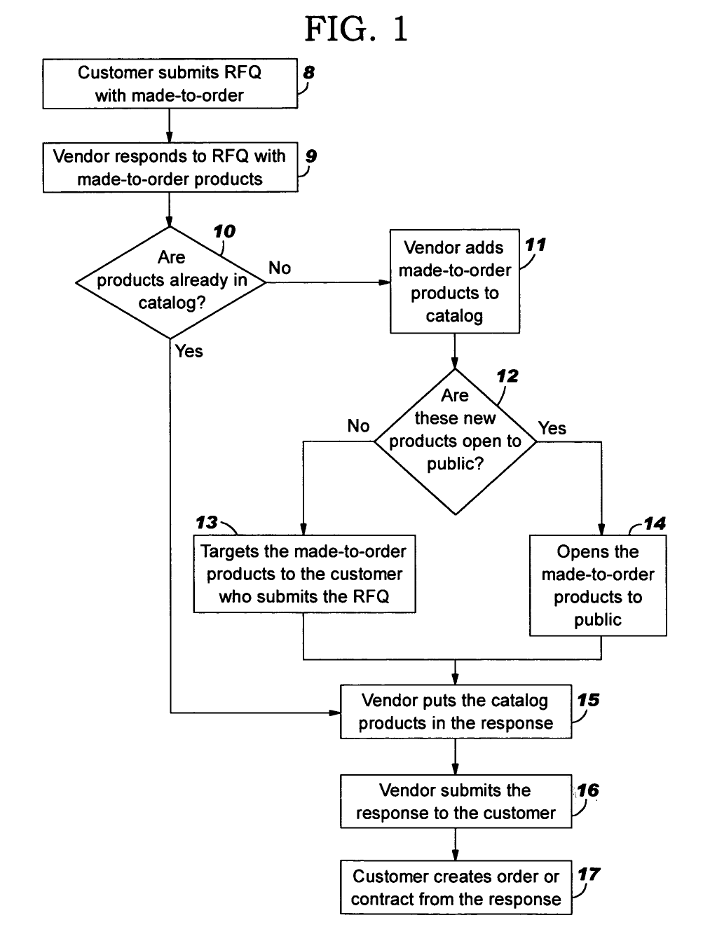

Referring to FIG. 1, which shows, in flowchart form, a method of a vendor e-commerce system to respond to made-to-order products included in an RFQ and add them to a catalog, it may be seen that, in step 8, a customer submits an RFQ to a vendor requesting a price quotation on specified made-to-order products. The vendor responds to the RFQ with the made-to-order products in step 9. It should be noted in this specific example that the made-to-order catalog product is created before the RFQ response is submitted. Whether the made-to-order product is created before or after the submission of the RFQ is not essential to the invention.

The vendor e-commerce system determines in step 10 if the made-to-order products are represented in the vendor e-commerce catalog. If the vendor e-commerce system cannot find an equivalent existing product in the catalog to substitute for the made-to-order product specified in the RFQ request, the vendor system can create a new catalog product listing for the made-to-order product in step 11. Once the new catalog product listing has been created, the vendor e-commerce system can refer to this new catalog entry, in a response to an RFQ, in a similar manner to other catalog entries.

If the new products are not desired by the vendor or customer to be sold to the general public and only to a specific customer, the e-commerce system makes that determination, in step 12, and targets them, in step 13, to the specific customer submitting the RFQ when creating the catalog product entry in step 15. The made-to-order product listings can also be put under a special category in the catalog, for example, “Made-To-Order,” so that clean up of the made-to-order products can be easily done, by the e-commerce system when required, e.g., at expiry of the RFQ relationship between customer and vendor.

If the made-to-order product is already represented by an equivalent in the catalog, the vendor e-commerce system can replace the made-to-order product with the equivalent product from the catalog in step 15.

If the made-to-order product was not previously in the catalog but is intended to be made available to the public, the e-commerce system flags the made-to-order products as available to the public, in step 14, in the catalog.

In step 16, the vendor submits the response to the customer, and in step 17, the customer creates an order or contract from the response, should the customer decide to purchase.

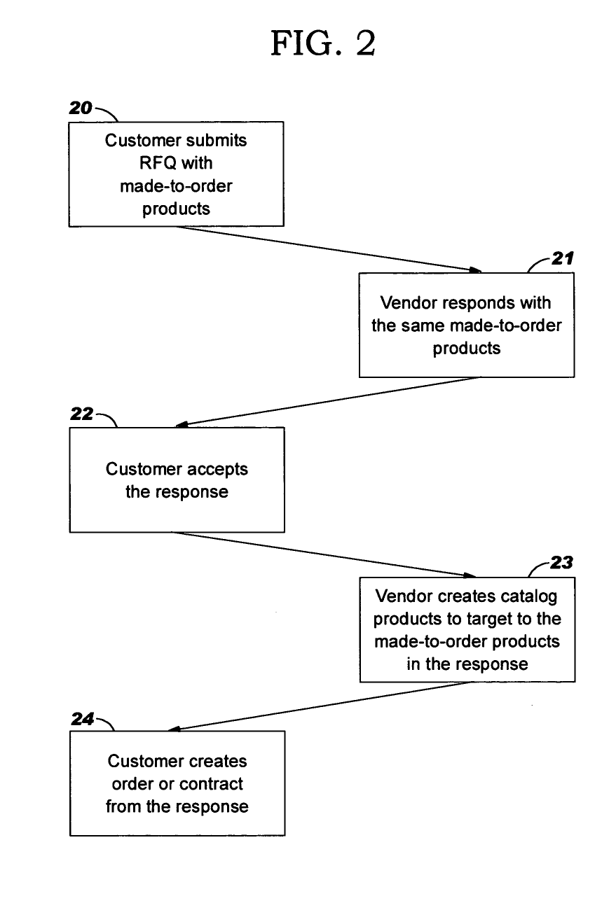

Referring to FIG. 2, which shows, in flowchart form, a method by the vendor e-commerce system to target products to an RFQ when creating catalog product listings, it can be seen in the case illustrated, the special made-to-order catalog product is not available initially. It is created after the vendor's response to the RFQ is accepted by the customer, but before an order or contract is created from the winning response.

In this illustration, a customer submits an RFQ for specified made-to-order products in step 20.

In step 21, the vendor e-commerce system responds to the RFQ for the made-to-order product with the product requested but without providing a valid catalog entry as no equivalent substitute product was available until later, after the response is accepted.

In step 22, the vendor e-commerce system is informed when the vendor's response is accepted by the customer. It should be noted in this illustration that the vendor needs to create the made-to-order product before the customer will be in a position to place an order from the vendor response or create a contract.

In step 23, when the vendor is informed that the customer has accepted, the vendor e-commerce system can target a product to the RFQ response, at catalog product listing creation time. Then, the new targeted product will be put in the accepted response, by the e-commerce system.

The customer will be informed when the made-to-order product is created and put in the accepted response by the vendor. Then, the accepted response can be converted to an order or contract in step 24.

Targeted products are supported through the catalog entitlement business policies. Business policies are sets of rules followed by a store or group of stores. Business policies define business processes, industry practices, and the scope and characteristics of a store's or group of stores' offerings. They are the central source and reference template for all allowed and supported practices within a store or group of stores. Entitlement business policies are created using a product set. A product set is a simple container that holds a list of catalog entries. Product sets can be referenced or governed by business policies or rules in a contract. As such, browsing certain catalog entries may not be permitted under a customer contract. You can include or exclude product sets in your online catalog.

Product sets provide a mechanism to partition the catalog into logical subsets. This partitioning allows the vendor to show different parts of the catalog to different users. If a vendor wants to target a catalog product, this can be done through the targeted product sets.

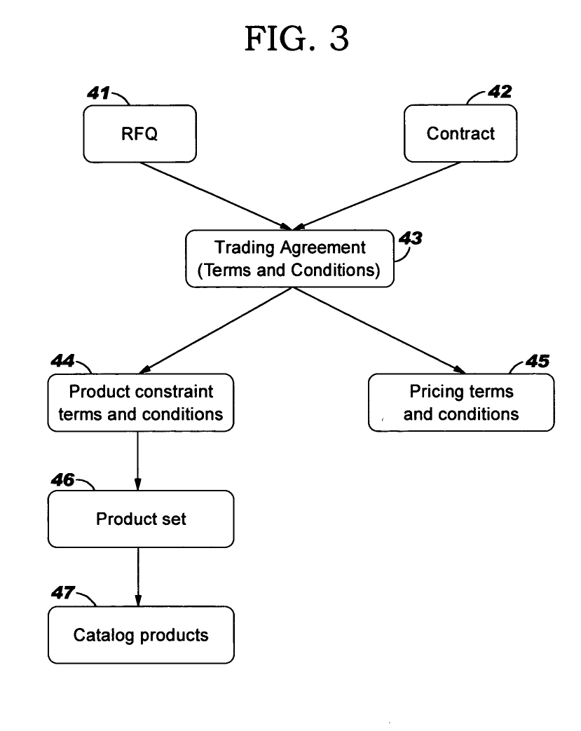

As shown in FIG. 3, both RFQs 41 and contracts 42 provide trading agreements which include terms and conditions 43 that cover information such as product pricing, returns and refunds, payment, shipping, and order approval. Product constraint terms and conditions 44 control which products are included or excluded for sale under a contract. Product constraint terms and conditions can be used to determine product sets 46. Product constraint terms may be optional. If no product constraint terms and conditions are specified in a contract, all products specified in the contract's price terms and conditions may be made available for sale under the trading agreement. The product constraint terms and conditions can specify an inclusion term (product set inclusion terms and conditions) or an exclusion term (product set exclusion terms and conditions). Products in an exclusion product set are not available for sale and those in an inclusion product sets are available for sale. Pricing terms and conditions 45 define the products that are available under a trading agreement and the prices a customer will pay for the products.

When a vendor creates catalog products 47, i.e., lists them in a catalog and targets them to a list of customers, the targeted products are added to an exclusion list of a base contract which is referenced by all contracts that do not have targeted product sets, and also added to inclusion lists of the contracts of targeted organizations. Then customers from the targeted organizations will be able to view all public (non-targeted) products in the catalog and those that are targeted to them.

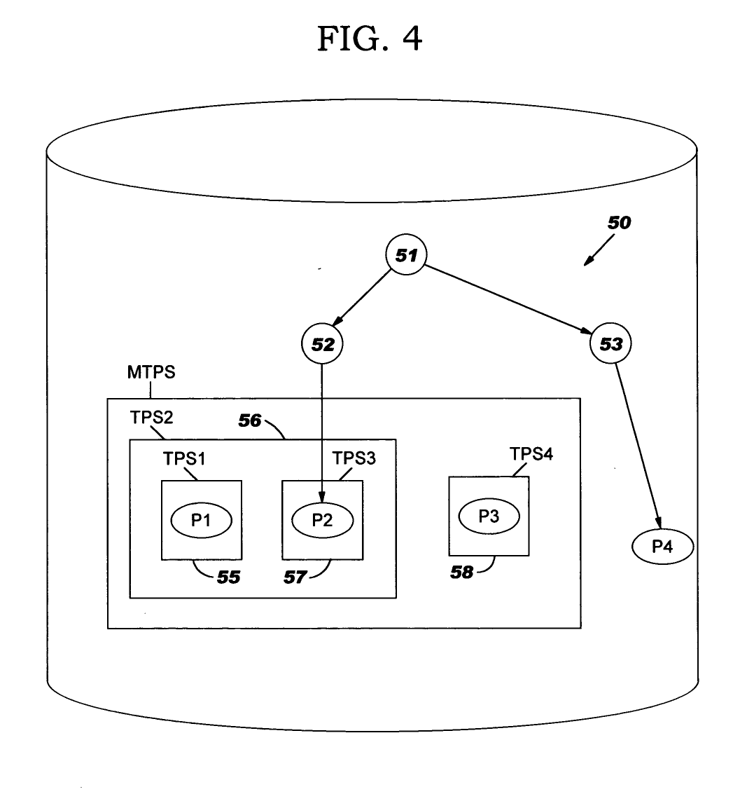

In order to appreciate the following discussion, reference should be made to the diagram of FIG. 4 which illustrates an example of a catalog 50 in accordance with this invention with target products using targeted product sets.

To support targeted products, it is useful for the e-commerce system of the invention to set up a master targeted product set (MTPS) 54 for all customers and a targeted product set (TPS) for each customer. Targeted product sets 55, 56, 57, and 58 are depicted.

When a catalog product is targeted to a customer, the targeted product is added to targeted product sets of the targeted customer. The targeted product is also added to the master targeted product set if it is not originally a targeted product.

Targeted product sets can be set up using the e-commerce system of the invention as follows:

A base contract is set up to exclude the master targeted product set (MTPS) for all targeted customers by adding Exclusion Product Set Terms and Conditions. When a contract refers to another contract, for example, contract A can refer to contract B, a customer who is entitled to contract A will be entitled to all the terms and conditions from contract A, as well as to all the terms and conditions in contract B. The store's default contract defines the default customer entitlement; for example, customers can access the master catalog and purchase products at standard prices. So, the store's default contract and all customer contracts without any targeted product sets should refer to the base contract in order to assure that all targeted products are excluded from contracts without targeted product sets.

Each customer will have a targeted product set (TPS) designated for it which is in an inclusion term of its customer contract with the vendor organization.

Each time a catalog product is targeted to a customer, this catalog product will be added to the targeted product set (TPS) designated to this customer and the master targeted product set (MTPS) for all customers.

This prerequisites a special contract with a targeted product set in the inclusion list existed between the customer and vendor organizations before a catalog product can be targeted to the customer.

If this contract cannot be found, an alternative that can be employed by an e-commerce system in accordance with the invention is:

Prevent targeting to this customer and return error message.

Guide the vendor to set up a contract with targeted product set in the inclusion list with the customer organization, Create a specific contract with the customer organization if no existing contract is found. This specific contract should not refer to the base contract that excludes all targeted products, i.e., the base contract excludes all targeted products.

Create a targeted product set (TPS) for this customer.

Put this targeted product set (TPS) in the inclusion list of the contract found or created.

Deploy the contract.

If no master targeted product set (MTPS) has been created, create one and insert it in the exclusion list of the base contract.

Insert the targeted catalog product in the new targeted product set (TPS) for this customer and the master targeted product set (MTPS) for all customers.

For example, referring to FIG. 4, the vendor targets catalog product PI to customers B1, B2, catalog product P2 to customers B2, B3, catalog product P3 to customer B4. Catalog product P4 is open to all customers. It will be appreciated that the result is the following 5 targeted product sets,

Master targeted product set (MTPS) 54 of products—P1, P2, P3

Targeted product set for customer B1 (TPS1) 55—P1

Targeted product set for customer B2 (TPS2) 56—P1, P2

Targeted product set for customer B3 (TPS3) 57—P2

Targeted product set for customer B4 (TPS4) 58—P3

The customers in the above example have different views of the catalog:

Customer B1 can view public product P4, and target catalog product P1, but not target catalog products P2, P3;

Customer B2 can view public product P4, and target catalog products P1, P2, but not target catalog product P3;

Customer B3 can view public product P4, and target product P2, but not target catalog products P1, P3;

Customer B4 can view public product P4, and target product P3, but not target catalog products P1, P2;

Other customers can view public product P4, but not target catalog products P1, P2 and P3.

Targeted product sets can be identified through special naming convention, for example, ‘TPS|store_id|customer_org’.

Targeted product sets identification information can also be kept in the database.

FIG. 4 also illustrates a hierarchical relationship that can be used for indexing the catalog 50. Root directory 51 for all products is divided into subdirectories, targeted product subdirectory 52 which references targeted products P1, P2, and P4, and public subdirectory 53 for non-targeted products, P4 in this case.

Maintenance of the catalog of the invention is relatively simple. When a customer is removed from the targeted list of catalog products, the catalog products are removed from the targeted product set of that customer. If this is the last targeted customer organization, these catalog products will be removed from the master targeted product set and can be opened for purchase by the public.

It should also be noted that the present invention may be implemented in a variety of network systems applications, including Internet, cable based, and hybrid Internet-cable systems. The various techniques described herein may be implemented in hardware or software, or a combination of both.

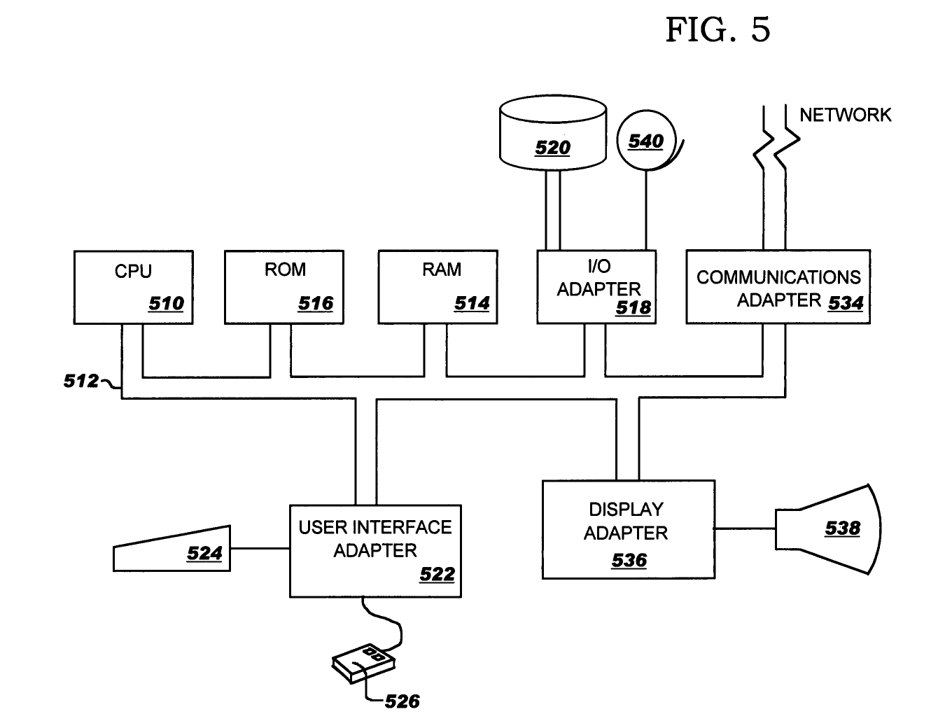

Referring to FIG. 5, an example is shown of a data processing system 500 which may be used for the invention. The system has a central processing unit (CPU) 510, which is coupled to various other components by system bus 512. Read only memory (“ROM”) 516 is coupled to the system bus 512 and includes a basic input/output system (“BIOS”) that controls certain basic functions of the data processing system 500. Random access memory (“RAM”) 514, I/O adapter 518, and communications adapter 534 are also coupled to the system bus 512. I/O adapter 518 may be a small computer system interface (“SCSI”) adapter that communicates with a disk storage device 520. Communications adapter 534 interconnects bus 512 with an outside network enabling the data processing system to communicate with other such systems, such as over the Internet. Input/Output devices are also connected to system bus 512 via user interface adapter 522 and display adapter 536. Keyboard 524 and mouse 526 are all interconnected to bus 512 via user interface adapter 522. Display monitor 538 is connected to system bus 512 by display adapter 536. In this manner, a user is capable of inputting to the system throughout the keyboard 524 or mouse 526 and receiving output from the system via display 538.

Implementations of the invention include implementations as a computer system(s) programmed to execute the method or methods described herein, and as a computer program product. According to the computer system implementation, sets of instructions for executing the method or methods may be resident in the random access memory 514 of one or more computer systems configured generally as described above. Until required by the computer system, the set of instructions may be stored as a computer program product in another computer memory, for example, in disk drive 520 (which may include a removable memory such as an optical disk or floppy disk for eventual use in the disk drive 520). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

What is claimed is:

1. An e-commerce catalog capable of offering a plurality of products for a vendor to prospective customers, comprising:
a master targeted product set of selected products that is not to be available to non-targeted customers; and
a targeted product set for a targeted customer.

2. The catalog of claim 1 wherein said catalog further comprises:
a non-targeted product set available to targeted customers.

3. The catalog of claim 2 wherein said non-targeted product set is available to public customers.

4. The catalog of claim 3 wherein said catalog presents views of products from targeted product sets to respective targeted customers.

5. The catalog of claim 4 wherein said catalog presents a view of products from non-targeted product sets to targeted customers.

6. The catalog of claim 5 wherein said catalog presents a view of products from non-targeted product sets to public customers.

7. The catalog of claim 1 wherein said master targeted product set is determined in accordance with terms and conditions of trading agreements between said vendor and said targeted customers.

8. The catalog of claim 7 wherein each said targeted product set is determined in accordance with the terms and conditions of a trading agreement between said vendor and a respective targeted customer.

9. A method of providing an e-commerce catalog capable of offering a plurality of products for a vendor to prospective customers, comprising the steps of:
providing for said catalog a master targeted product set of selected products that is not to be available to non-targeted customers; and
providing for said catalog a targeted product set for a targeted customer.

10. The method of providing an e-commerce catalog of claim 13 further providing for said catalog a non-targeted product set available to targeted customers.

11. The method of providing an e-commerce catalog of claim 10 wherein said non-targeted product set is made available to public customers.

12. A computer program product for implementing an e-commerce catalog, capable of offering a plurality of products for a vendor to prospective customers said computer program product comprising a computer usable medium having computer readable program code means embodied in said medium, and comprising computer readable program code means for providing:
a master targeted product set of selected products that is not to be available to non-targeted customers; and
a targeted product set for a respective targeted customer.

13. The computer program product for implementing an e-commerce catalog of claim 12 wherein said catalog further comprises computer readable program code for providing a non-targeted product set available to targeted customers.

14. The computer program product for implementing an e-commerce catalog of claim 13 wherein said non-targeted product set is available to public customers.

15. The computer program product for implementing an e-commerce catalog of claim 14 wherein said catalog presents views of products from targeted product sets to respective targeted customers.

16. The computer program product for implementing an e-commerce catalog of claim 13 wherein said catalog presents views of products from targeted product sets and non-targeted product sets.

17. The computer program product for implementing an e-commerce catalog of claim 12 wherein said master targeted product set is determined in accordance with terms and conditions of trading agreements between said vendor and said targeted customers.

18. The computer program product for implementing an e-commerce catalog of claim 17 wherein each said targeted product set is determined in accordance with the terms and conditions of a trading agreement between said vendor and a respective targeted customer.

19. The computer program product for implementing an e-commerce catalog of claim 18 wherein catalog pricing of products from said master targeted product set is determined in accordance with terms and conditions of trading agreements between said vendor and said targeted customers.

20. The computer program product for implementing an e-commerce catalog of claim 18 wherein catalog pricing of products from said targeted product sets is determined in accordance with terms and conditions of trading agreements between said vendor and respective targeted customers.
